(19) United States
(12) Patent Application Publication
(10) Pub. No.: US 2026/0270034 A1
(43) Pub. Date: Sep. 10, 2026

(54) METHOD AND APPARATUS FOR ACTIVATING OR DEACTIVATING A SEMI-PERSISTENT SOUNDING REFERENCE SIGNAL FOR POSITIONING

(71) Applicant: Mentats Co., Ltd., Seoul (KR)

(72) Inventor: DaeHeum PARK, Suwon-si (KR)

(21) Appl. No.: 19/275,474

(22) Filed: Jul. 21, 2025

(30) Foreign Application Priority Data
Mar. 5, 2025 (KR) 10-2025-0028094

(51) Int. Cl. H04L 5/00

(52) U.S. Cl. CPC H04L 5/0098; H04L 5/0048

(57) ABSTRACT

Described are a method and apparatus for activating or deactivating a semi-persistent (SP) sounding reference signal (SRS) in a wireless communication system. A terminal may receive a medium access control (MAC) control element (CE) for activation or deactivation of an SP positioning SRS resource set, and may activate or deactivate the SP positioning SRS resource set. The MAC CE may include a first field indicating whether to activate or deactivate the SP positioning SRS resource set, and a second field indicating a type of spatial relation information. The type of spatial relation information may be related to one of i) a channel state information-reference signal (CSI-RS) resource index, ii) a synchronization signal block (SSB) index, iii) an SRS resource index and iv) a downlink-positioning reference signal (DL-PRS) index.

### CROSS-REFERENCE TO RELATED APPLICATIONS

This application claims the priority of Korean Patent Application No. 10-2025-0028094 filed on Mar. 5, 2025, in the Korean Intellectual Property Office, the disclosure of which is incorporated herein by reference.

### BACKGROUND OF THE DISCLOSURE

### Field of the disclosure

The present disclosure relates to a wireless communication system applicable to 4G, 5G and 6G.

### Related Art

With the continuous development of mobile communication technologies, the transition from 4G to 5G has brought about significant improvements in various aspects of wireless communication. These advancements are designed to meet the ever-growing demands of modern applications, such as high-speed mobile broadband, massive connectivity for Internet of Things (IoT) devices, and ultra-reliable low-latency communications. The key areas of development in 5G can be categorized into enhanced Mobile Broadband (eMBB), massive Machine Type Communications (mMTC), and Ultra-Reliable Low-Latency Communications (URLLC), each addressing distinct use cases and requirements that were challenging for 4G technologies.

Enhanced Mobile Broadband (eMBB)

In 4G, Long-Term Evolution (LTE) technology provided high-speed mobile broadband, with peak download speeds reaching up to 1 Gbps. While this met the needs of high-definition video streaming, mobile gaming, and other data-intensive services, the increasing demand for higher speeds and larger data volumes necessitated further innovation. 5G addresses these challenges by offering up to 20 Gbps download speeds, enabling new applications such as 4K/8K video streaming, virtual reality (VR), augmented reality (AR), and large-scale data transfers. The introduction of technologies such as massive MIMO, beamforming, and the use of millimeter-wave frequencies have enabled 5G to deliver these improved capabilities, meeting the growing demand for mobile broadband.

Massive Machine Type Communications (mMTC)

The emergence of the Internet of Things (IoT) has brought about the need for a vast number of connected devices. However, 4G LTE technology was not optimized for massive device connectivity, as it primarily focused on human-to-human communication. Moreover, 4G faced limitations in terms of energy efficiency, scalability, and the ability to handle a large number of connected devices simultaneously. 5G addresses these issues by introducing mMTC, which supports the connection of millions of devices with minimal energy consumption and long battery life. By utilizing Low-Power Wide-Area Networks (LPWAN) and network slicing, 5G ensures efficient connectivity for massive IoT deployments, including smart cities, agriculture, healthcare, and other large-scale IoT ecosystems.

### Ultra-Reliable Low-Latency Communications (URLLC)

4G networks, while offering low latency for mobile broadband, were not optimized for ultra-reliable and real-time communication, which is essential for applications such as autonomous driving, remote surgery, and industrial automation. The need for ultra-reliable, low-latency communication with near-instantaneous response times prompted the development of URLLC in 5G. With 5G, latency is reduced to as low as 1 millisecond, enabling real-time communication and control. This advancement is critical for applications that require immediate decision-making, such as autonomous vehicles that rely on real-time vehicle-to-vehicle and vehicle-to-infrastructure communication, as well as remote medical procedures and industrial automation systems that require precise, instantaneous control.

These developments have made 5G a pivotal technology in transforming the way industries operate and society interacts with the digital world. The ongoing evolution from 4G to 5G represents a significant leap forward in enabling new use cases, increasing network efficiency, and enhancing user experience.

Looking ahead, 6G is expected to further expand the capabilities of 5G, focusing on even higher speeds, ultra-high reliability, and the integration of advanced technologies like AI and holographic communications. It is anticipated that 6G will enable more immersive and seamless experiences, such as truly ubiquitous connectivity, advanced immersive technologies like mixed reality (XR), and autonomous systems that operate in real-time with zero latency. The evolution from 4G to 5G and eventually to 6G highlights the continuous progress in wireless communication technologies and their increasing role in shaping the future of the digital world.

### SUMMARY OF THE DISCLOSURE

The disclosure is to provide a method and apparatus for efficiently activating or deactivating a semi-persistent (SP) positioning sounding reference signal (SRS) in a wireless communication system.

According to an embodiment, a method of a terminal may be provided for operating in a wireless communication system. The method of the terminal may include receiving a medium access control (MAC) control element (CE) for activation or deactivation of a semi-persistent (SP) positioning sounding reference signal (SRS) resource set, and activating or deactivating the SP positioning SRS resource set. The MAC CE may include a first field indicating whether to activate or deactivate the SP positioning SRS resource set, and a second field indicating a type of spatial relation information. The type of spatial relation information may be related to one of i) a channel state information-reference signal (CSI-RS) resource index, ii) a synchronization signal block (SSB) index, iii) an SRS resource index and iv) a downlink-positioning reference signal (DL-PRS) index.

According to another embodiment, a terminal may be provided for operating in a wireless communication system. The terminal may include a processor configured to cause the terminal to receive a medium access control (MAC) control element (CE) for activation or deactivation of a semi-persistent (SP) positioning sounding reference signal (SRS) resource set. The processor is further configured to cause the terminal to activate or deactivate the SP positioning SRS resource set. The MAC CE may include a first field indicating whether to activate or deactivate the SP positioning SRS resource set, and a second field indicating a type of spatial relation information. The type of spatial relation information may be related to one of i) a channel state information-reference signal (CSI-RS) resource index, ii) a synchronization signal block (SSB) index, iii) an SRS resource index and iv) a downlink-positioning reference signal (DL-PRS) index.

The value of the second field may correspond to one of 00 for the CSI-RS resource index, 01 for the SSB index, 10 for the SRS resource index and 11 for the DL-PRS index.

When the value of the second field is set to 10 for the SRS resource index, the MAC CE may further include a third field indicating either a first index corresponding to an SRS resource or a second index corresponding to a positioning SRS resource. In addition, when the MAC CE is used for activation of the SP positioning SRS resource set in a radio resource control (RRC) inactive state, the third field may only indicate the second index corresponding to the positioning SRS resource.

The SP positioning SRS resource set may be initially deactivated.

The terminal may transmit an SRS based on the activated SP positioning SRS resource set.

When the value of the second field is set to 10 for the SRS resource index, the MAC CE may further include a fourth field indicating a resource type, being either the SRS resource or the positioning SRS resource.

When the MAC CE is used for activation of the SP positioning SRS resource set in the RRC inactive state, setting the value of the second field to 00 for the CSI-RS resource index may not be applicable.

### BRIEF DESCRIPTION OF THE DRAWINGS

FIG. 1 illustrates a wireless communication system.

FIG. 2 illustrates UE state machine and state transitions in NR.

FIG. 3 illustrates an example procedure for SP positioning SRS configuration and activation.

FIG. 4 illustrates a medium access control (MAC) control element (CE) for SP positioning SRS activation and deactivation.

FIGS. 5A to 5D illustrate various spatial relation fields in a MAC CE for SP positioning SRS activation.

FIG. 6 is a flowchart showing a method of operating a terminal (UE) according to an embodiment of the disclosure.

FIG. 7 is a block diagram showing apparatuses according to an embodiment of the disclosure.

### DESCRIPTION OF EXEMPLARY EMBODIMENTS

The technical terms used in this disclosure are intended to describe specific embodiments and should not be construed as limiting. Unless otherwise defined, these terms should be interpreted according to their generally understood meanings by those skilled in the art, without being overly broad or narrow. If a term does not fully represent the spirit of the disclosure, it should be understood as the most accurate technical term recognized by those skilled in the art.

The use of a slash (/) or a comma in the present disclosure may represent “and/or.” For example, “A/B” may indicate “A and/or B,” meaning it can refer to “only A,” “only B,” or “both A and B.”.

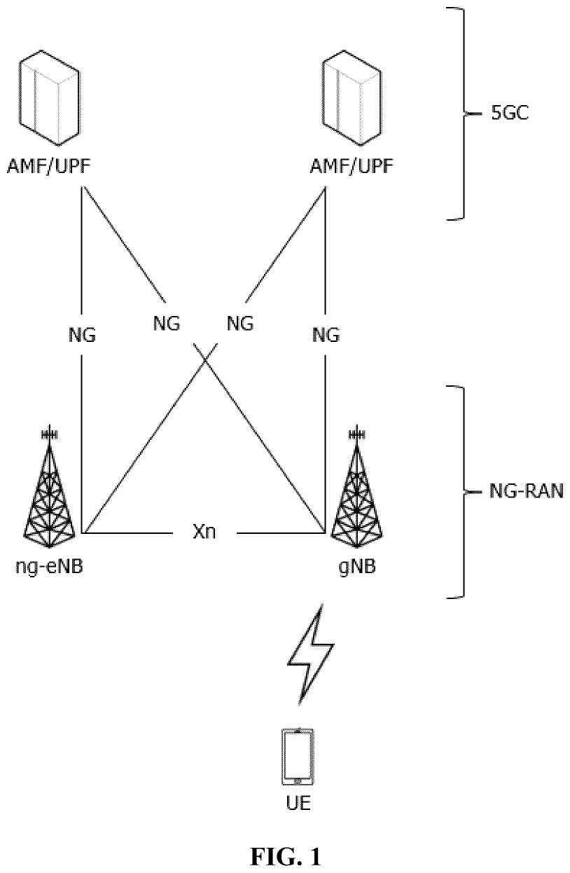

FIG. 1 illustrates a wireless communication system.

Referring to FIG. 1, the wireless communication system may be classified into a 5G core network (5GC) and a next generation-radio access network (NG-RAN), and the NG-RAN may include a base station (gNB and/or ng-eNB) that provides user plane and control plane protocol termination to a terminal (user equipment, UE). A next generation-Node B (gNB) provides an NR user plane and control plane protocol termination to the terminal, and a next generation-evolved node B (ng-eNB) provides an evolved-universal terrestrial radio access (E-UTRA) user plane and control plane protocol termination to the terminal(UE). The terminal(UE) may be fixed or mobile, and may be referred to as another term such as a mobile station (MS), a user terminal (UT), a subscriber station (SS), a mobile terminal (MT), a wireless device, etc. The base station (gNB and/or ng-eNB) may be a fixed station communicating with the terminal(UE), and may be referred to as another term such as a base transceiver system (BTS), an access point, etc.

The base station (gNB and/or ng-eNB) may be connected to each other through an Xn interface, and may be connected to a 5G core network (5GC) through an NG interface. Specifically, the base station (gNB and/or ng-eNB) may be connected to an access and mobility management function (AMF) through an NG-C interface, and may be connected to a user plane function (UPF) through an NG-U interface.

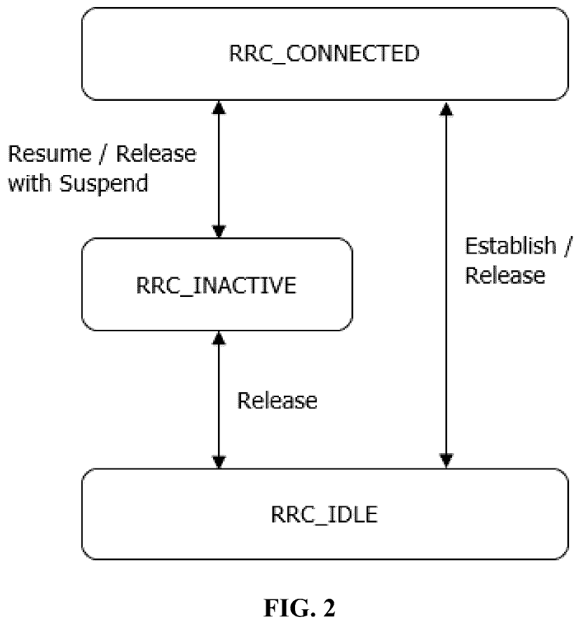

FIG. 2 illustrates UE state machine and state transitions in NR.

A UE is either in RRC_CONNECTED state or in RRC_INACTIVE state when an RRC connection has been established. If this is not the case, i.e. no RRC connection is established, the UE is in RRC_IDLE state. The RRC states can further be characterised as follows:
1. RRC_IDLE:
A UE specific DRX (Discontinuous Reception) may be configured by upper layers;
At lower layers, the UE may be configured with a DRX for PTM (Point to Multipoint) transmission of MBS(Multicast/Broadcast Services) broadcast;
UE controlled mobility based on network configuration;
The UE:
i) Monitors Short Messages transmitted with P-RNTI (Paging-RNTI) over DCI (Downlink Control Information);
ii) Monitors a Paging channel for CN (Core Network) paging using 5G-S-TMSI (5G-Serving-Temporary Mobile Subscriber Identity), except if the UE is acting as a L2(Layer 2) U2N (UE-to-Network) Remote UE;

iii) If configured by upper layers for MBS multicast reception, monitors a Paging channel for CN paging using TMGI (Temporary Mobile Group Identity);

iv) Performs neighbouring cell measurements and cell (re-)selection;

v) Performs measurements on L2 U2N Relay UEs and relay (re-)selection;

vi) Acquires system information and can send SI request (if configured);

vii) Performs logging of available measurements together with location and time for logged measurement configured UEs;

viii) Performs idle/inactive measurements for idle/inactive measurement configured UEs;

ix) If configured by upper layers for MBS broadcast reception, acquires MCCH change notification and MBS broadcast control information and data.
2. RRC_INACTIVE:
A UE specific DRX may be configured by upper layers or by RRC layer;
At lower layers, the UE may be configured with a DRX for PTM transmission of MBS broadcast and/or a DRX for PTM transmission of MBS multicast;
UE controlled mobility based on network configuration;
The UE stores the UE Inactive AS (Access Stratum) context;
A RAN-based notification area is configured by RRC layer;
Transfer of unicast data and/or signalling to/from UE over radio bearers configured for SDT.
The UE:
i) Monitors Short Messages transmitted with P-RNTI over DCI;
ii) While T319a is running, monitors control channels associated with the shared data channel to determine if data is scheduled for it;
iii) While T319a is not running, monitors a Paging channel for CN paging using 5G-S-TMSI and RAN paging using fullI-RNTI (full Inactive RNTI), except if the UE is acting as a L2 U2N Remote UE;
iv) If configured by upper layers for MBS multicast reception, while T319a is not running, monitors a Paging channel for paging using TMGI;
v) Performs neighbouring cell measurements and cell (re-)selection;
vi) Performs measurements on L2 U2N Relay UEs and relay (re-)selection;
vii) Performs RAN-based notification area updates periodically and when moving outside the configured RAN-based notification area;
viii) Acquires system information and, while SDT (Small Data Transmission) procedure is not ongoing, can send SI (System Information) request (if configured);
ix) While SDT procedure is not ongoing, performs logging of available measurements together with location and time for logged measurement configured UEs;
x) While SDT procedure is not ongoing, performs idle/inactive measurements for idle/inactive measurement configured UEs;
xi) If configured by upper layers for MBS broadcast reception, acquires MCCH (MBS Control Channel) change notification and MBS broadcast control information and data;
xii) If configured for MBS multicast reception in RRC_INACTIVE, acquires multicast MCCH change notification and MBS multicast control information and data;
xiii) Transmits SRS (Sounding Reference Signal) for Positioning.
3. RRC_CONNECTED:
The UE stores the AS context;
Transfer of unicast data to/from UE;
Transfer of MBS multicast data to UE;
At lower layers, the UE may be configured with a UE specific DRX;
At lower layers, the UE may be configured with a DRX for PTM transmission of MBS broadcast and/or a DRX for MBS multicast;
At lower layers, the UE may be configured with a cell specific cell DTX/DRX;
For UEs supporting CA (Carrier Aggregation), use of one or more SCells (Secondary Cells), aggregated with the SpCell (Special Cell), for increased bandwidth;
For UEs supporting DC (Dual Connectivity), use of one SCG (Secondary Cell Group), aggregated with the MCG (Master Cell Group), for increased bandwidth;
Network controlled mobility within NR, to/from E-UTRA, and to UTRA-FDD;
Network controlled mobility (path switch) between a serving cell and a L2 U2N Relay UE, or vice versa, or between a source L2 U2N Relay UE and a target L2 U2N Relay UE;
Network controlled MP (Multi-Path) operation.
The UE:
i) Monitors Short Messages transmitted with P-RNTI over DCI, if configured;
ii) Monitors control channels associated with the shared data channel to determine if data is scheduled for it;
iii) Provides channel quality and feedback information;
iv) Performs neighbouring cell and/or L2 U2N relay measurements and measurement reporting;
v) Acquires system information;
vi) Performs immediate MDT measurement together with available location reporting;
vii) If configured by upper layers for MBS broadcast reception, acquires MCCH change notification and MBS broadcast control information and data

A sounding reference signal (SRS) may be used for uplink channel sounding and positioning purposes in a wireless communication system. Among various types of SRS transmissions, a semi-persistent (SP) positioning SRS refers to an SRS that is pre-configured for periodic transmission by a user equipment (UE) to support uplink-based positioning. The SP positioning SRS allows a network to estimate the location of the UE based on uplink measurements such as time of arrival (ToA), angle of arrival (AoA), or other radio parameters obtained from the received SRS at one or more base stations.

The SP positioning SRS may be configured through radio resource control (RRC) signaling using a dedicated SRS positioning resource sets (SRS-PosResourceSet) and associated SRS positioning resources (SRS-PosResources). Once configured, activation or deactivation of the SP positioning SRS may be controlled through a medium access control (MAC) control element (CE), enabling efficient use of uplink resources while maintaining positioning accuracy. This mechanism supports precise location estimation of the UE in the RRC_CONNECTED state, and may also operate even when the UE is in an RRC_INACTIVE state.

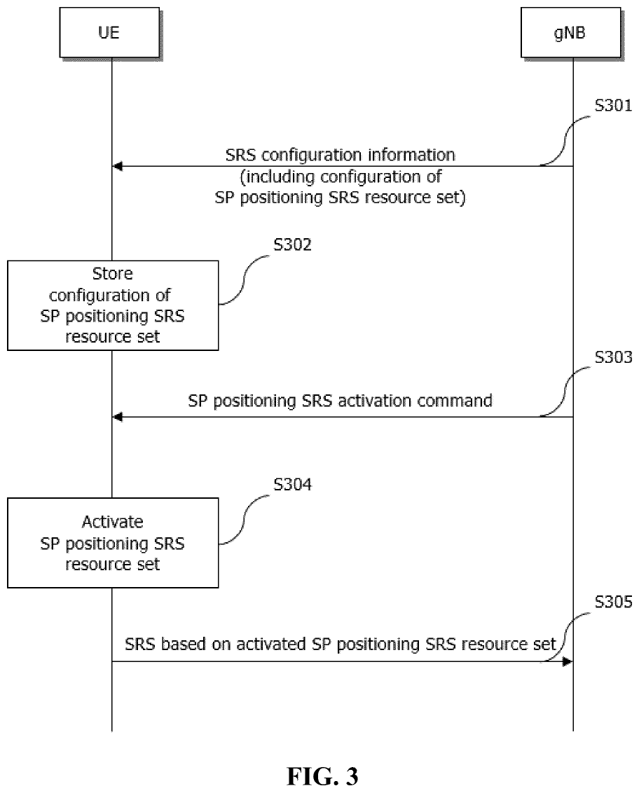

FIG. 3 illustrates an example procedure for SP positioning SRS configuration and activation.

Referring to FIG. 3, a UE receives, from a base station (gNB), SRS configuration information that includes configuration of at least one SP positioning SRS resource set (S301). Upon reception, the UE stores the configuration of the SP positioning SRS resource set(s) (S302), which may include information such as resource identifiers, periodicity, antenna ports, frequency and time domain parameters, and spatial relation settings.

Subsequently, the UE receives an activation command, such as a MAC control element (CE), from the gNB to activate the configured SP positioning SRS resource set (S303). The UE activates the indicated SP positioning SRS resource set based on the received activation command (S304). Thereafter, the UE transmits an SRS based on the activated SP positioning SRS resource set (S305), thereby allowing the network (e.g., gNB or a location management entity) to perform uplink-based positioning measurements.

When an SP positioning SRS is configured by a higher layer parameter, such as SRS-PosResource, and when the higher layer parameter spatialRelationInfoPos (i.e., spatial relation information for positioning) is also configured, the spatialRelationInfoPos includes an identity of the configuration fields of a reference reference signal (RS). The reference RS may be one of the following: an SRS configured by SRS resource (SRS-Resource) or SRS positioning resources (SRS-PosResource), a channel state information-reference signal (CSI-RS), a synchronization signal/physical broadcast channel (SS/PBCH) block, or a downlink positioning reference signal (DL PRS), each of which may be configured on either a serving cell or a non-serving cell.

In particular, when the UE is configured to transmit an SP positioning SRS in the RRC_INACTIVE state, the spatialRelationInfoPos remains applicable except in cases where the reference RS is an SRS configured by SRS-Resource or a CSI-RS. In such cases, only an SRS configured by SRS-PosResource may be used as a valid source reference signal for spatial relation indication in a medium access control (MAC) control element (CE) for activating the SP positioning SRS. That is, in the RRC_INACTIVE state, a non-zero power CSI-RS (NZP CSI-RS) or an SRS configured by SRS-Resource cannot be used as a reference RS for the purpose of indicating spatial relation. The aforementioned higher layer parameters are transmitted from the base station to the UE.

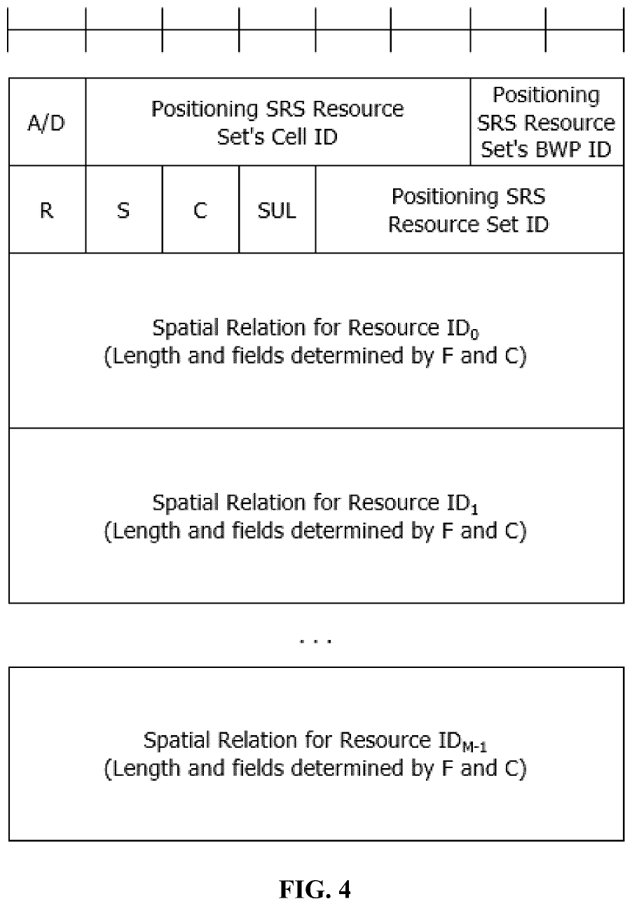

FIG. 4 illustrates a medium access control (MAC) control element (CE) for SP positioning SRS activation and deactivation.

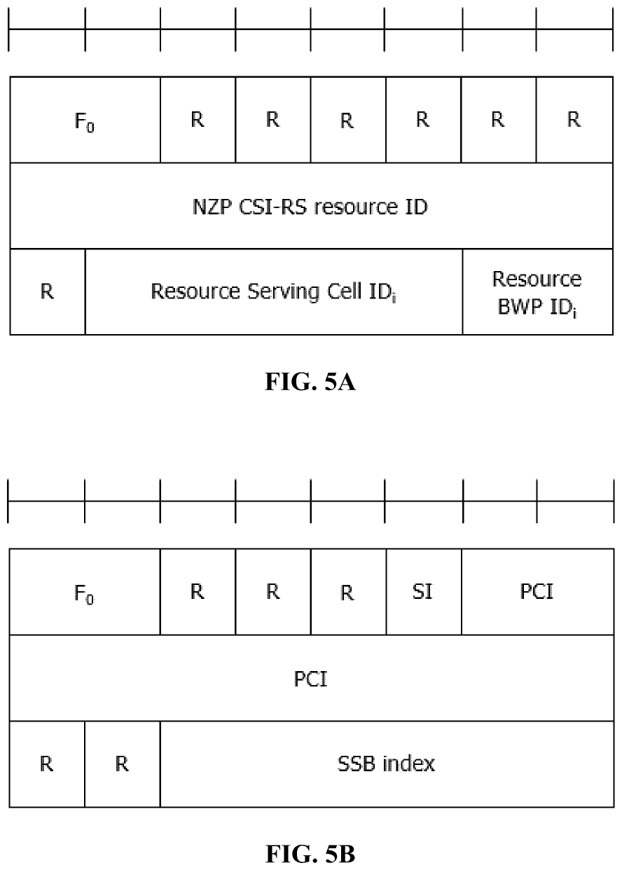

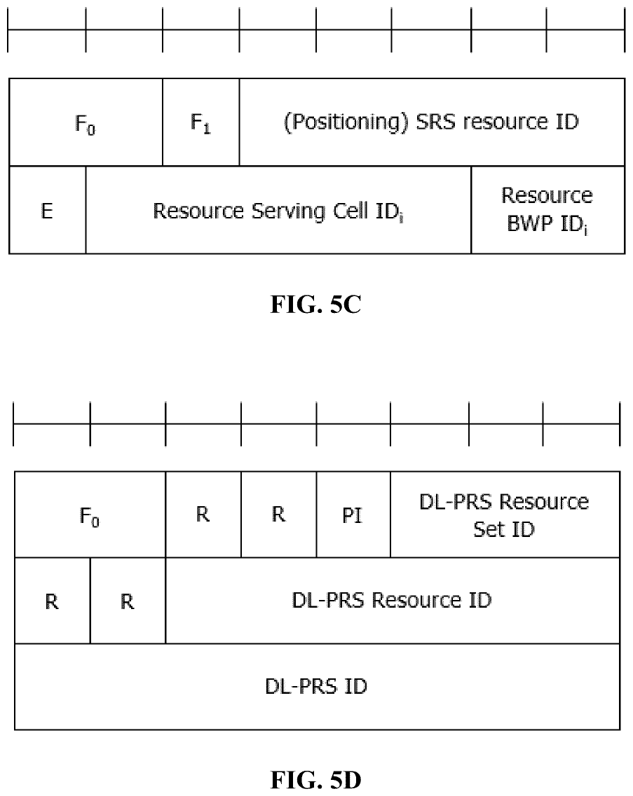

In FIG. 4, the details of the aforementioned MAC CE for activating or deactivating SP positioning SRS are shown. The SP positioning SRS activation/deactivation MAC CE is identified by a MAC subheader with an extended logical channel ID (eLCID) value. The MAC CE comprises an array of 8-bit octets, and has a variable size with the following fields.
A/D: This field indicates whether to activate or deactivate indicated SP positioning SRS resource set. The field is set to 1 to indicate activation, otherwise it indicates deactivation.
Positioning SRS Resource Set's Cell ID: This field indicates the identity of the serving cell, which contains activated/deactivated SP positioning SRS resource set. If the MAC CE is used for activation/deactivation of the SP positioning SRS transmission in RRC_INACTIVE, this field indicates the identity of the cell from where positioning SRS configuration was received. If the C field is set to 0, this field also indicates the identity of the serving cell which contains all resources indicated by the Spatial Relation for Resource IDᵢ fields, if present. The length of the field is 5 bits.
Positioning SRS Resource Set's BWP ID: This field indicates an uplink bandwidth part (UL BWP) as the codepoint of the DCI bandwidth part indicator field, which contains activated/deactivated SP positioning SRS resource set. If the C field is set to 0, this field also indicates the identity of the BWP which contains all resources indicated by the Spatial Relation for Resource IDᵢ fields, if present. If the MAC CE is used for activation/deactivation of the SP positioning SRS transmission in RRC_INACTIVE and the SP positioning SRS is configured outside the initial BWP, this field should be ignored by UE. The length of the field is 2 bits.
C: This field indicates whether the octets containing Resource Serving Cell ID field(s) and Resource BWP ID field(s) within the field Spatial Relation for Resource IDᵢ are present, except for Spatial Relation Resource IDᵢ with DL-PRS or SSB. When A/D is set to 1, if this field is set to 1, the octets containing Resource Serving Cell ID field(s) and Resource BWP ID field(s) in the field Spatial Relation for Resource IDᵢ are present, otherwise if this field is set to 0, they are not present. When A/D is set to 0, this field is always set to 0 that they are not present.
SUL: This field indicates whether the MAC CE applies to the normal uplink (NUL) carrier or supplementary uplink (SUL) carrier configuration. This field is set to 1 to indicate that it applies to the SUL carrier configuration, and it is set to 0 to indicate that it applies to the NUL carrier configuration.
Positioning SRS Resource Set ID: This field indicates the SP positioning SRS resource set identified by SRS-PosResourceSetId, which is to be activated or deactivated. The length of the field is 4 bits.
Spatial Relation for Resource IDᵢ: The field Spatial Relation for Resource IDᵢ is only present if MAC CE is used for activation, i.e. the A/D field is set to 1. M is the total number of Positioning SRS resource(s) configured under the SP positioning SRS resource set indicated by the field Positioning SRS Resource Set ID. There are 4 types of Spatial Relation for Resource IDᵢ, which is indicated by the F (F0 and F1) field within. The fields within Spatial Relation for Resource IDᵢ are shown in FIGS. 5A to 5D for the 4 types of Spatial Relations for Resource IDᵢ.
S: This field indicates whether the fields Spatial Relation for Resource ID; for the positioning SRS resource i within the positioning SRS resource set are present. If the field is set to 1, the fields Spatial Relation for Resource IDᵢare present; otherwise, they are absent;
R: Reserved bit, set to 0.

FIGS. 5A to 5D illustrate various spatial relation fields in a MAC CE for SP positioning SRS activation.

The 4 types of the “Spatial Relation for Resource IDᵢ” field, corresponding to NZP CSI-RS, SSB, SRS and DL-PRS, are shown in FIGS. 5A to 5D, respectively. The field “Spatial Relation for Resource IDᵢ” consists of the following fields:
F0: This field indicates the type of a resource used as a spatial relation for the i^{th} positioning SRS resource within the positioning SRS resource set indicated with the field Positioning SRS Resource Set ID. The field is set to 00 to indicate NZP CSI-RS resource index is used; it is set to 01 to indicate SSB index is used; it is set to 10 to indicate SRS resource index is used; it is set to 11 to indicate DL-PRS index is used. The length of the field is 2 bits. When the MAC CE is used for SP SRS activation in RRC_INACTIVE, the field should not be set to 00.
F1: This field indicates the type of SRS resource used as spatial relation for the i^{th} positioning SRS resource within the SP positioning SRS resource set indicated with the field Positioning SRS Resource Set ID when F0 is set to 10. The field is set to 0 to indicate SRS resource index (SRS-ResourceId); the field is set to 1 to indicate positioning SRS resource index (SRS-PosResourceId) is used.
NZP CSI-RS Resource ID: This field contains an index of “NZP-CSI-RS-ResourceID”, indicating the NZP CSI-RS resource, which is used to derive the spatial relation for the positioning SRS. The length of the field is 8 bits.
SSB index: This field contains an index of SSB (SSB-Index). The length of the field is 6 bits.
PCI: This field contains physical cell identity (PhysCellId). The length of the field is 10 bits.
SRS resource ID: When F1 is set to 0, the field indicates an index for SRS resource (SRS-ResourceId); When F1 is set to 1, the field indicates an index for Positioning SRS resource (SRS-PosResourceId). When the MAC CE is used for SP SRS activation in RRC_INACTIVE, this field can only indicate an index for positioning SRS resource (SRS-PosResourceId) configured in RRC_INACTIVE. The length of the field is 5 bits representing the index from 0 to 31.
E: This field indicates the extension of SRS resource ID as the most significant bit (MSB) of SRS resource ID. The total length of the extended SRS resource ID is 6 bits. If E bit is set to 1, the SRS resource ID value is 5-bit SRS resource ID field+32.
DL-PRS Resource Set ID: This field contains an index for DL-PRS Resource Set (nr-DL-PRS-ResourceSetId). The length of the field is 3 bits.
DL-PRS Resource ID: This field contains an index for DL-PRS resource (nr-DL-PRS-Resource-Id). The length of the field is 6 bits
DL-PRS ID: This field contains an identity for DL-PRS resource (dl-PRS-ID). The length of the field is 8 bits.
PI: This field indicates whether the field DL-PRS resource ID is present within the Spatial Relation for Resource IDᵢ with DL-PRS. If the field is set to 1, the octet containing the field DL-PRS resource ID is present; otherwise, the octet is omitted.
SI: This field indicates whether the field SSB index is present within the Spatial Relation for Resource IDᵢ with SSB. If the field is set to 1, the octet containing the field SSB index is present; otherwise, the octet is omitted.
Resource Serving Cell IDᵢ: This field indicates the identity of the serving cell on which the resource used for spatial relationship derivation for the i^{th} positioning SRS resource is located. The length of the field is 5 bits.
Resource BWP IDᵢ: This field indicates a UL BWP as the codepoint of the DCI “bandwidth part indicator” field, on which the resource used for spatial relationship derivation for the iₜₕ positioning SRS resource is located. The length of the field is 2 bits.

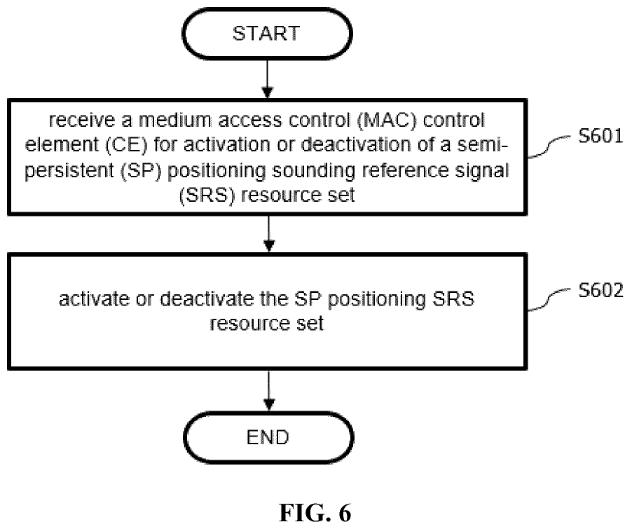

FIG. 6 is a flowchart showing a method of operating a terminal (UE) according to an embodiment of the disclosure.

Referring to FIG. 6, the terminal receives a medium access control (MAC) control element (CE) for activation or deactivation of a semi-persistent (SP) positioning sounding reference signal (SRS) resource set (S601). Then, the terminal activates or deactivates the SP positioning SRS resource set (S602). The MAC CE may include a first field indicating whether to activate or deactivate the SP positioning SRS resource set, and a second field indicating a type of spatial relation information. The type of spatial relation information may be related to one of i) a channel state information-reference signal (CSI-RS) resource index, ii) a synchronization signal block (SSB) index, iii) an SRS resource index and iv) a downlink-positioning reference signal (DL-PRS) index.

The value of the second field may correspond to one of 00 for the CSI-RS resource index, 01 for the SSB index, 10 for the SRS resource index and 11 for the DL-PRS index.

When the value of the second field is set to 10 for the SRS resource index, the MAC CE may further include a third field indicating either a first index corresponding to an SRS resource or a second index corresponding to a positioning SRS resource. In addition, when the MAC CE is used for activation of the SP positioning SRS resource set in a radio resource control (RRC) inactive state, the third field may only indicate the second index corresponding to the positioning SRS resource.

The SP positioning SRS resource set may be initially deactivated.

The terminal may transmit an SRS based on the activated SP positioning SRS resource set.

When the value of the second field is set to 10 for the SRS resource index, the MAC CE may further include a fourth field indicating a resource type, being either the SRS resource or the positioning SRS resource.

When the MAC CE is used for activation of the SP positioning SRS resource set in the RRC inactive state, setting the value of the second field to 00 for the CSI-RS resource index may not be applicable.

Meanwhile, when the terminal is configured to transmit SP positioning SRS in the RRC_INACTIVE state, only the SRS configured by the SRS-PosResource can be used as a valid reference signal to indicate the spatial relation via the MAC CE for activation. Additionally, to clearly indicate that the MAC CE applies to the RRC_INACTIVE state, the “R” (reserved) bit shown in FIG. 4 may be utilized. Specifically, when the “R” bit is set to 1, it indicates the RRC_INACTIVE state, and in association with the “R” bit being set to 1, the third field described above can only indicate the second index corresponding to the positioning SRS resource. Here, the name “R” may alternatively be referred to as “I” (inactive) or another appropriate term.

The disclosure described so far may be implemented through various means. For example, the embodiment may be implemented by hardware, firmware, software, or a combination thereof. Specifically, the implementation will be described below with reference to the accompanying drawing.

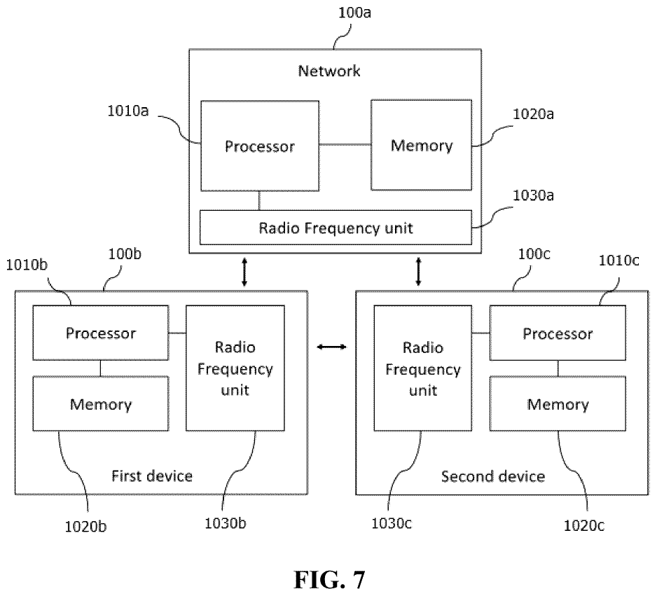

FIG. 7 is a block diagram showing apparatuses according to an embodiment of the disclosure.

Referring to FIG. 7, a wireless communication system may include a network 100a, a first apparatus 100b and a second apparatus 100c.

The network 100 a may include a base station, a network node, an apparatus related to 5G service, or other apparatuses related to the fourth industrial revolution.

The first device 100b may include a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second device 100c may include a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IOT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The network 100a may include at least one processor such as a processor 1010a, at least one memory such as a memory 1020a and at least one radio frequency unit such as a radio frequency unit 1030a. The processor 1010a may be tasked with executing the previously mentioned functions, procedures, and/or methods. The processor 1010a may be capable of implementing one or more protocols. For example, the processor 1010a may perform and manage one or more layers of a radio interface protocol. The memory 1020a may be connected to the processor 1010a, and configured to store various types of information and/or instructions. The radio frequency unit 1030a may be connected to the processor 1010a, and controlled to transceive radio signals.

The first device 100b may include at least one processor such as a processor 1010b, at least one memory such as a memory 1020b and at least one radio frequency unit such as a radio frequency unit 1030b. The processor 1010b may be tasked with executing the previously mentioned functions, procedures, and/or methods. The processor 1010b may be capable of implementing one or more protocols. For example, the processor 1010b may perform and manage one or more layers of a radio interface protocol. The memory 1020b may be connected to the processor 1010b, and configured to store various types of information and/or instructions. The radio frequency unit 1030b may be connected to the processor 1010b, and controlled to transceive radio signals.

The second device 100c may include at least one processor such as a processor 1010c, at least one memory such as a memory 1020c and at least one radio frequency unit such as a radio frequency unit 1030c. The processor 1010c may be tasked with executing the previously mentioned functions, procedures, and/or methods. The processor 1010c may be capable of implementing one or more protocols. For example, the processor 1010c may perform and manage one or more layers of a radio interface protocol. The memory 1020c may be connected to the processor 1010c, and configured to store various types of information and/or instructions. The radio frequency unit 1030c may be connected to the processor 1010c, and controlled to transceive radio signals.

The memory 1020a, the memory 1020b and/or the memory 1020c may be respectively connected inside or outside the processor 1010a, the processor 1010b and/or the processor 1010c and connected to other processors through various technologies such as wired or wireless connection.

According to the embodiment of the disclosure, activation or deactivation of a semi-persistent (SP) positioning sounding reference signal (SRS) can be efficiently performed in a wireless communication system.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

1. A method for a terminal to operate in a wireless communication system, the method comprising:
receiving a medium access control (MAC) control element (CE) for activation or deactivation of a semi-persistent (SP) positioning sounding reference signal (SRS) resource set; and
activating or deactivating the SP positioning SRS resource set,
wherein the MAC CE includes a first field indicating whether to activate or deactivate the SP positioning SRS resource set, and a second field indicating a type of spatial relation information,
wherein the type of spatial relation information is related to one of i) a channel state information-reference signal (CSI-RS) resource index, ii) a synchronization signal block (SSB) index, iii) an SRS resource index and iv) a downlink-positioning reference signal (DL-PRS) index,
wherein a value of the second field corresponds to one of 00 for the CSI-RS resource index, 01 for the SSB index, 10 for the SRS resource index and 11 for the DL-PRS index,
wherein, when the value of the second field is set to 10 for the SRS resource index, the MAC CE further includes a third field indicating either a first index corresponding to an SRS resource or a second index corresponding to a positioning SRS resource,
wherein, when the MAC CE is used for activation of the SP positioning SRS resource set in a radio resource control (RRC) inactive state, a CSI-RS resource corresponding to the CSI-RS resource index and the SRS resource corresponding to the first index are not used as a reference signal for spatial relation, and
wherein i) the second field is restricted to one of values corresponding to the SSB index, the SRS resource index and the DL-PRS index, excluding the CSI-RS resource index, and ii) the third field only indicates the second index corresponding to the positioning SRS resource.

2. The method of claim 1, wherein the SP positioning SRS resource set is initially deactivated.

3. The method of claim 1, further comprising:
transmitting an SRS based on the activated SP positioning SRS resource set.

4. The method of claim 1, wherein, when the value of the second field is set to 10 for the SRS resource index, the MAC CE further includes a fourth field indicating a resource type, being either the SRS resource or the positioning SRS resource.

5. (canceled)

6. A terminal in a wireless communication system comprising:
a processor configured to cause the terminal to:
receive a medium access control (MAC) control element (CE) for activation or deactivation of a semi-persistent (SP) positioning sounding reference signal (SRS) resource set; and
activate or deactivate the SP positioning SRS resource set,
wherein the MAC CE includes a first field indicating whether to activate or deactivate the SP positioning SRS resource set, and a second field indicating a type of spatial relation information,
wherein the type of spatial relation information is related to one of i) a channel state information-reference signal (CSI-RS) resource index, ii) a synchronization signal block (SSB) index, iii) an SRS resource index and iv) a downlink-positioning reference signal (DL-PRS) index,
wherein a value of the second field corresponds to one of 00 for the CSI-RS resource index, 01 for the SSB index, 10 for the SRS resource index and 11 for the DL-PRS index,
wherein, when the value of the second field is set to 10 for the SRS resource index, the MAC CE further includes a third field indicating either a first index corresponding to an SRS resource or a second index corresponding to a positioning SRS resource,
wherein, when the MAC CE is used for activation of the SP positioning SRS resource set in a radio resource control (RRC) inactive state, a CSI-RS resource corresponding to the CSI-RS resource index and the SRS resource corresponding to the first index are not used as a reference signal for spatial relation, and
wherein i) the second field is restricted to one of values corresponding to the SSB index, the SRS resource index and the DL-PRS index, excluding the CSI-RS resource index, and ii) the third field only indicates the second index corresponding to the positioning SRS resource.

7. The terminal of claim 6, wherein the SP positioning SRS resource set is initially deactivated.

8. The terminal of claim 6, wherein the processor is further configured to cause the terminal to:
transmit an SRS based on the activated SP positioning SRS resource set.

9. The terminal of claim 6, wherein, when the value of the second field is set to 10 for the SRS resource index, the MAC CE further includes a fourth field indicating a resource type, being either the SRS resource or the positioning SRS resource.

10. (canceled)
